(19) United States
(12) Patent Application Publication
(10) Pub. No.: US 2004/0179999 A1
(43) Pub. Date: Sep. 16, 2004

(54) Submicron particle enhanced catalysts and process for producing synthesis gas

(75) Inventors: Rafael L. Espinoza, Ponca City, OK (US); Kandaswamy Jothimurugesan, Ponca City, OK (US); Gloria I. Straguzzi, Ponca City, OK (US); Gary E. Welch, Ponca City, OK (US)

Correspondence Address: DAVID W. WESTPHAL, CONOCOPHILLIPS COMPANY, P.O. BOX 1267, PONCA CITY, OK, 74602-1267, US

(73) Assignee: ConocoPhillips Company, Houston, TX

(21) Appl. No.: 10/389,064

(22) Filed: Mar. 14, 2003

(51) Int. Cl. C01B 3/26

(52) U.S. Cl. 423/651; 502/302

(57) ABSTRACT

A submicron-particle-enhanced catalyst and method for its making are disclosed. The catalyst comprises <1 micron diameter particles distributed over the surface of a monolith or divided carrier to provide a high surface area catalyst having highly dispersed catalytic active sites available for catalyzing fast chemical reactions at short contact time and high space time yield. A syngas production method carried out in a short contact time reactor is disclosed in which a gaseous stream of light hydrocarbon and O₂ is passed over a submicron-particle-enhanced catalyst to produce a mixture of carbon monoxide and hydrogen.

### BACKGROUND OF THE INVENTION

1. Field of the Invention

The present invention generally relates to methods of increasing catalyst surface area and dispersion of catalytic components on refractory carriers, and more particularly to methods of producing high surface area, highly dispersed catalysts for the catalytic partial oxidation of light hydrocarbons (e.g., methane and natural gas) to produce a mixture of carbon monoxide and hydrogen (“synthesis gas” or “syngas”) at high space velocities.

2. Description of Related Art

The quantities of methane, the main component of natural gas, are available in many areas of the world, and natural gas is predicted to outlast oil reserves by a significant margin. However, most natural gas is situated in areas that are geographically remote from population and industrial centers. The costs of compression, transportation, and storage make its use economically unattractive.

To improve the economics of natural gas use, much research has focused on methane as a starting material for the production of higher hydrocarbons and hydrocarbon liquids. The conversion of methane to hydrocarbons is typically carried out in two steps. In the first step, methane is reformed with water to produce carbon monoxide and hydrogen (i.e., synthesis gas or syngas). In a second step, the syngas intermediate is converted to higher hydrocarbon products by processes such as the Fischer-Tropsch Synthesis. For example, fuels with boiling points in the middle distillate range, such as kerosene and diesel fuel, and hydrocarbon waxes may be produced from the synthesis gas.

Current industrial use of methane as a chemical feedstock proceeds by the initial conversion of methane to carbon monoxide and hydrogen by either steam reforming, which is the most widespread process, or by dry reforming or by autothermal reforming. Steam reforming currently is the major process used commercially for the conversion of methane to synthesis gas, proceeding according to Equation 1.

CH₄+H₂O⇄CO+3H₂ (1)

Although steam reforming has been practiced for over five decades, efforts to improve the energy efficiency and reduce the capital investment required for this technology continue. For many industrial applications, the 3:1 ratio of H₂:CO products is problematic, and the typically large steam reforming plants are not practical to set up at remote sites of natural gas formations.

Methane residence times in steam reforming are on the order of 0.5-1 second, whereas for heterogeneously catalyzed partial oxidation, the residence time is on the order of a few milliseconds. For the same production capacity, syngas facilities for the partial oxidation of methane can be far smaller, and less expensive, than facilities based on steam reforming. A recent report (M. Fichtner et al. Ind. Eng. Chem. Res. (2001) 40:3475-3483) states that for efficient syngas production, the use of elevated operation pressures of about 2.5 MPa is required. Those authors describe a partial oxidation process in which the exothermic complete oxidation of methane is coupled with the subsequent endothermic reforming reactions (water and CO₂ decomposition). This type of process can also be referred to as autothermal reforming or ATR, especially when steam is co-fed with the methane. Certain microstructured rhodium honeycomb catalysts are employed which have the advantage of a smaller pressure drop than beds or porous solids (foams) and which resist the reaction heat of the total oxidation reaction taking place at the catalyst inlet. The honeycomb is made by welding together a stack of rhodium foils that have been microstructured by means of wire erosion or cutting.

The catalytic partial oxidation (“CPOX”) or direct partial oxidation of hydrocarbons (e.g., natural gas or methane) to syngas has also been described in the literature. In catalytic partial oxidation, natural gas is mixed with air, oxygen-enriched air, or oxygen, and introduced to a catalyst at elevated temperature and pressure. The partial oxidation of methane yields a syngas mixture with a H₂:CO ratio of 2:1, as shown in Equation 2.

CH₄+1/2O₂→CO+2H₂ (2)

This ratio is more useful than the H₂:CO ratio from steam reforming for the downstream conversion of the syngas to chemicals such as methanol or to fuels. The CPOX reaction is exothermic, while the steam reforming reaction is strongly endothermic. Furthermore, oxidation reactions are typically much faster than reforming reactions. This allows the use of much smaller reactors for catalytic partial oxidation processes that is possible in a conventional steam reforming process.

While its use is currently limited as an industrial process, the direct partial oxidation or CPOX of methane has recently attracted much attention due to its inherent advantages, such as the fact that due to the significant heat that is released during the process, there is no requirement for the continuous input of heat in order to maintain the reaction, in contrast to steam reforming processes.

In 1989, an attempt to overcome some of the disadvantages and costs typical of steam reforming by production of synthesis gas via the catalytic partial oxidation of methane was disclosed in European Patent No. 303,438. According to that method, certain high surface area monoliths coated with metals or metal oxides that are active as oxidation catalysts, e.g., Pd, Pt, Rh, Ir, Os, Ru, Ni, Cr, Co, Ce, La, and mixtures thereof, were suggested as catalysts. Other suggested coating metals are noble metals and metals of groups IA, IIA, III, IV, VB, VIB, or VIIB of the periodic table of the elements.

Over the ensuing years, a variety of catalysts and methods for improving the catalytic partial oxidation process have been devised, and are described in the literature. For example, Dietz III and Schmidt (Catalysis Letters (1995) 33:15-29) describe the effects of 1.4-6 atmospheres pressure on methane conversion and product selectivities in the direct oxidation of methane over a Rh-coated foam monolith. The selectivities of catalytic partial oxidation to the desired products, carbon monoxide and hydrogen, are controlled by several factors. One of the most important of these factors is the choice of catalyst composition.

In most of the existing syngas production processes it is difficult to select a catalyst that will be economical for large scale industrial use, yet will provide the desired level of activity and selectivity for CO and H₂ and demonstrate long on-stream life. Moreover, such high conversion and selectivity levels must be achieved without detrimental effects to the catalyst, such as the formation of carbon deposits (“coke”) on the catalyst, which severely reduces catalyst performance. Accordingly, substantial effort in this field continues to be devoted to the development of catalysts allowing commercial performance without coke formation. Also, in order to avoid high pressure drop associated with gas flow through the catalyst, and to make possible the operation of the reactor at high gas space velocities, various types of structures for supporting the active catalyst in the reaction zone have been proposed. Typical syngas catalysts are formed as, or carried on, a porous refractory oxide (i.e., ceramic) foam monolith. For example, U.S. Pat. No. 5,658,497 describes a process for the catalytic partial oxidation of hydrocarbons using a ceramic foam support impregnated with an inorganic oxide catalyst. Generally, any organic or aqueous liquid in which the metal salt is soluble may be used to deposit the catalytic metal onto the support.

U.S. Pat. No. 5,510,056 discloses a monolithic support such as a ceramic foam or fixed catalyst system having a specified tortuosity and number of interstitial pores that is said to allow operation at high gas space velocity. Catalysts used in that process include ruthenium, rhodium, palladium, osmium, iridium, and platinum. Data are presented in that patent for a ceramic foam supported rhodium catalyst at a rhodium loading of from 0.5-5.0 wt %.

U.S. Pat. No. 5,648,582 also discloses a process for the catalytic partial oxidation of a feed gas mixture consisting essentially of methane. The methane-containing feed gas mixture and an oxygen-containing gas are passed over an alumina foam supported metal catalyst at space velocities of 120,000 h⁻¹ to 12,000,000 h⁻¹ The catalytic metals exemplified are rhodium and platinum, at a loading of about 10 wt %.

One reason for using a catalyst support such as a foam monolith, or of forming the catalytic components into a three-dimensional structure that contains many small pores, is to obtain a high catalyst surface area and high catalytic metal dispersion, for enhancing the number of exposed catalytic sites. The catalyst may also be made in the form of a packed bed of finely divided particles obtain a high catalyst surface area and high dispersion of the catalytic metal. One of the typical drawbacks of packed-bed high surface area particulate catalysts and of microporous structured monoliths is that the pressure drop is too great to allow high space velocity operation.

Other syngas catalysts are in the form of solid metal sintered monoliths or washcoated “honeycomb” straight channel monoliths or extrudates, or other configuration having longitudinal channels or passageways permitting high space velocities with a minimal pressure drop. Such configurations are known in the art and are well-described in the literature. A drawback of these more “open” structures is that in typical multichannel or honeycomb supports, the total open porosity comprises average pore size of about 1-50 μm, more typically about 3-10 μm. Such pore sizes are too small to permit adequate amounts of typical metal oxide washcoat particles to impregnate the interior surfaces of the support. Another common problem with monolith-type high surface area catalysts is that at high metal loadings, sintering and loss of activity occurs. Still another problem is that the usual monolith impregnation techniques tend to yield non-homogeneous distributions of the catalytic material on the support, which can adversely affect the flow of the process gases and promote undesirable side reactions. Some of the difficulties associated with depositing oxide layers and catalytic materials onto conventional supports are discussed by X. Xu and J. A. Moulijn, “Transformation of a Structured Carrier into Structured Catalyst” STRUCTURED CATALYSTS AND REACTORS, A. Cybulski and J. A. Moulijn (Eds.), Marcel Dekker, Inc., 1998, (Ch. 21) p. 599-615.

K. L. Hohn and L. D. Schmidt (Applied Catalysis A: General (2001) 211:53-68) describe the effect of space velocity on the partial oxidation of methane using two types of catalyst support geometries. Synthesis gas production by certain rhodium coated monoliths and spheres is discussed, and it is suggested that differences in heat transfer within the two support geometries may play a major role in the different results in catalytic performance observed between spheres and monoliths at increased space velocity. The authors indicate that factors other than chemistry, such as mass and heat transfer within the catalyst region, appear to be important at high flow rates.

Ruckenstein and Wang (Appl. Catal., A (2000) 198:33-41; J. Catal. (1999) 186:181-187) describe certain MgO supported Rh catalysts containing different Rh dispersions after reduction. At 750° C. and 1 atm, those catalysts provided a conversion >80% and selectivities of 95-96% to CO and 96-98% to H₂, at the high space velocity of 7.2×10⁵ mL/g⁻¹h⁻¹, with very high stability over a defined period of time. The high stability of the catalysts is attributed to the strong interactions between rhodium and magnesium oxides. In today's syngas production processes, productivity typically falls off when the process is operated at superatmospheric pressure.

U.S. Pat. No. 4,863,707 describes certain catalysts comprising a lanthia-chromia-alumina flit impregnated with platinum, paladium or rhodium. The frit is deposited on alumina beads or on a monolith. A shallow bed of the frit-coated beads or a frit-coated monolith is used for the partial oxidation stage of an autothermal reforming process.

Catalyzed chemical processes that rely on very fast reactions, such as the catalytic partial oxidation of light hydrocarbon to produce synthesis gas, require high flow rates and low pressure drop through the catalyst bed in order to have applicability for large-scale industrial use. Packed catalyst beds are generally less able to provide the required high catalyst surface area and low resistance to flow than are monolith-type catalysts because super fine catalyst particles capable of providing the requisite high surface area become too densely packed. There is also a susceptibility to microfluidization of particle beds at high flow rates.

The demands on CPOX catalysts that are to be used industrially for high space time yield of synthesis gas are severe, and, in addition to enduring very high space velocities and superatmospheric pressures, the catalysts must endure high temperatures (up to about 1,500-2,000° C.) and thermal shocks. In order for a CPOX-based syngas production process to be commercially feasible, the catalyst must also be sufficiently active for converting a light hydrocarbon and highly selective for the desired CO and H₂ products under the CPOX operating conditions, capable of a long life on stream without coking, and also economical enough for industrial scale use. At the present time, none of the known partial oxidation syngas catalysts appear to satisfy all of those requirements. Typically, partial oxidation reactor operation under pressure is problematic because of shifts in equilibrium, undesirable secondary reactions, coking and catalyst instability. Another problem frequently encountered is loss of noble metals due to catalyst instability at higher operating temperatures. Although advancement has been made toward providing higher levels of conversion of reactant gases and better selectivities for CO and H₂ reaction products, problems still remain with finding sufficiently stable and long-lived catalysts capable of conversion rates that are attractive for large scale industrial use. Accordingly, a continuing need exists for better catalysts for the production of synthesis gas, particularly from methane or methane containing feeds.

### SUMMARY OF PREFERRED EMBODIMENTS

In accordance with the present invention, a way is provided to combine the advantages of high surface area particles, highly dispersed catalytic materials, and high porosity monolith catalyst structure to make catalysts that are capable of operating in high space-time yield processes. Termed “submicron-particle-enhanced catalysts”, the preferred catalysts comprise a monolith or particulate carrier coated with a plurality of supported catalyst particles that are less than one micrometer (1 micron (μ)) in diameter or along the particle's longest dimension. These “submicron-size particles” enhance or increase the surface area of the monolith or particulate carrier, and improve the dispersion and availability of the catalytically active sites of the supported catalyst, compared to a conventional washcoated or impregnated carrier.

Also provided are a syngas production method and syngas catalysts that overcome many of the problems associated with existing processes and catalysts, and for the first time make possible the high space-time yields of CO and H₂ that are necessary in a commercially feasible syngas production facility. A process of preparing synthesis gas using a highly dispersed, high surface area catalyst structure that is active for catalyzing the partial oxidation (CPOX) of methane or natural gas is disclosed. One advantage of the new catalyst structures is that they demonstrate a high level of hydrocarbon conversion and selectivity to carbon monoxide and hydrogen products under conditions of high gas hourly space velocity, elevated pressure and moderate to high temperature. The preferred catalyst structures contain increased surface area catalysts with more highly dispersed catalytic material which overcome some of the drawbacks of previous supported catalysts, to provide higher conversion and syngas selectivity.

In addition, the use of these submicron-sized particle enhanced catalysts that have superior activity for syngas generation under a variety of operating conditions, and at lower temperatures than that reported in earlier work is demonstrated. These catalysts provide a way to achieve high volume throughput of the reactant gas mixture and at the same time expose the reactant gas mixture to a larger catalytic surface than is possible with typical syngas catalysts.

In accordance with certain embodiments of the present invention a method or process of converting methane or natural gas and O₂ to a product gas mixture containing CO and H₂ (“syngas”), preferably in a molar ratio of about 2:1H₂:CO, is provided. The process comprises mixing a methane-containing feedstock and an O₂ containing feedstock to provide a reactant gas mixture feedstock. Natural gas, or other light hydrocarbons having from 2 to 5 carbon atoms, and mixtures thereof, may also serve as satisfactory feedstocks. The O₂ containing feedstock may be pure oxygen gas, or may be air or O₂-enriched air. The reactant gas mixture may also include incidental or non-reactive species, in lesser amounts than the primary hydrocarbon and oxygen components. Some such species are H₂, CO, N₂, NOx, CO₂, N₂O, Ar, SO₂ and H₂S, as can exist normally in natural gas deposits. Additionally, in some instances, it may be desirable to include nitrogen gas in the reactant gas mixture to act as a diluent. Nitrogen can be present by addition to the reactant gas mixture or can be present because it was not separated from the air that supplies the oxygen gas. The reactant gas mixture is fed into a reactor where it comes into contact with a catalytically effective amount of a submicron-particle-enhanced catalyst, as described above. Certain preferred embodiments of the process are capable of operating at superatmospheric reactant gas pressures (preferably in excess of 2 atmospheres or about 200 kPa) to efficiently produce synthesis gas.

In accordance with certain embodiments of the present invention, a method of partially oxidizing a reactant gas mixture comprising a light hydrocarbon and oxygen to form a product mixture containing carbon monoxide and hydrogen is provided. The method comprises passing the reactant gas mixture over a catalyst in a reactor to produce a product mixture containing CO and H₂. The catalyst comprises a large number of submicron-size refractory support particles containing catalytically active material with the support particles attached to a refractory carrier. The refractory carrier can be a monolith, with a network of regular or irregular channels, or it can be made up of divided structures such as a plurality of refractory particles that are larger than the submicron-size particles. Preferably at least a majority (i.e., >50%) of the particles or distinct structures have a maximum characteristic length (i.e., longest dimension) of less than six millimeters, preferably less than three millimeters.

In some embodiments the catalyst comprises (a) a refractory carrier that is larger than 1 micron in diameter or in its longest dimension, (b) catalytically active material, including any promoters, (c) refractory particles having a diameter or largest dimension less than 1 micron, with the particles affixed to or coating the carrier, (d) at least a portion of the catalytically active material on or in the refractory particles, and, optionally, (e) at least a portion of the catalytically active material on the refractory carrier itself.

In some embodiments the catalyst is made by a method that includes coating at least a portion of the refractory carrier with a plurality of submicron-size support particles, to provide a submicron-particle-enhanced carrier. Each of the support particle have an external surface with catalytic metal crystallites disposed thereon, are impregnated with said catalytic material, or comprise catalytic material and refractory support material mixed together. Alternatively, the particles can have any combination of those compositional features. The method includes determining a pressure drop per length of the resulting monolith catalyst, or packed bed of particulate catalyst, of no less than 0.1 psi/cm (0.7 kPa/cm). In more preferred embodiments the pressure drop is no less than 0.2 psi/com (1.4 kPa/cm), and still more preferred embodiments the pressure drop is no less than 0.5 psi/cm (3.4 kPa/cm). In some embodiments of the method in which the catalyst bed comprises particles, at least 50%, more preferably 70% or more, of the carrier particles are 50 to 6000 microns in diameter. For example, when forming a catalyst bed 12 mm long×12.5 mm diameter for a laboratory-scale syngas production reactor operating at superatmospheric pressure and gas hourly space velocity in excess of 100,000 h⁻¹. In certain embodiments the catalyst bed length to diameter ratio (L/D) is between about 0.05 and about 1.0, preferably between about 0.1 to about 0.5, and more preferably in the range of about 0.15 to about 0.40.

In certain embodiments, the carrier comprises a refractory material such as zirconia, alumina, α-alumina, cordierite, titania, mullite, zirconia-stabilized α-alumina, partially stabilized zirconia, MgO stabilized alumina, silica, vanadia or niobia, or any combination thereof. In certain embodiments the partially stabilized zirconia contains a stabilizer such as Mg, Ca or Y. In certain embodiments, the catalyst comprises rhodium and a lanthanide chosen from the group consisting of Pr, Sm, and Yb, and in certain embodiments the submicron-sized particles comprise about 0.5-10 wt % Rh, about 0.5-10 wt % Sm and a refractory support material.

According to certain embodiments of the present invention, the reactant gas mixture is passed over an above-described enhanced surface area catalyst in a reactor under process conditions that include maintaining a molar ratio of methane to oxygen ratio in the range of about 1.5:1 to about 3.3:1, the gas hourly space velocity is maintained in excess of about 20,000 h⁻¹, the reactant gas mixture is maintained at a pressure in excess of about two atmospheres, which is advantageous for optimizing syngas production space-time yields. In some embodiments, the reactant gas mixture is preheated to a temperature in the range of about 30° C.-750° C. before contacting the catalyst. The preheated feed gases pass through the catalytic materials to the point at which the partial oxidation reaction initiates. An overall or net catalytic partial oxidation (CPOX) reaction ensues, and the reaction conditions are maintained to promote continuation of the process, which preferably is sustained autothermally.

For the purposes of this disclosure, the term “net partial oxidation reaction” means that the partial oxidation reaction shown in Reaction 2, above, predominates. However, other reactions such as steam reforming (see Reaction 1), dry reforming (Reaction 3) and/or water-gas shift (Reaction 4) may also occur to a lesser extent.

CH₄+CO₂→2 CO+2H₂ (3)

CO+H₂O⇄CO₂+H₂ (4)

The relative molar amounts of the CO and H₂ in the reaction product mixture resulting from the catalytic net partial oxidation of the methane, or natural gas, and oxygen feed mixture are about 2:1 H₂:CO, similar to the stoichiometric amounts produced in the partial oxidation reaction of Reaction 2.

The net partial oxidation reaction conditions are promoted by optimizing the concentrations of hydrocarbon and O₂ in the reactant gas mixture, preferably within the range of about a 1.5:1 to about 3.3:1 molar ratio of carbon:O₂, preferably about 2:1. In some embodiments, steam may also be added to produce extra hydrogen and to control the outlet temperature. The ratio of steam to carbon by weight ranges from 0 to 1. The carbon:O₂ ratio is the most important variable for maintaining the autothermal reaction and the desired product selectivities. Pressure, residence time, amount of feed preheat and amount of nitrogen dilution, if used, also affect the reaction products. The process also includes maintaining a catalyst residence time of no more than about 200 milliseconds for the reactant gas mixture, preferably less than 20 milliseconds, and more preferably 10 milliseconds or less.

This is accomplished by passing the reactant gas mixture over, or through the porous structure of the catalyst system at a gas hourly space velocity of about 20,000-100,000,000 h⁻¹, preferably about 100,000-25,000,000 h⁻¹. This range of preferred gas hourly space velocities corresponds to a weight hourly space velocity of 1,000 to 25,000 h⁻¹. In preferred embodiments of the process, the catalyst system catalyzes the net partial oxidation of at least 80% of a methane feedstock to CO and H₂ with a selectivity for CO and H₂ products of at least about 80% CO and 80% H₂.

In certain embodiments of the process; the step of maintaining net partial oxidation reaction promoting conditions includes keeping the temperature of the reactant gas mixture at about 30° C.-750° C. and keeping the temperature of the catalyst at about 600-2,000° C., preferably between about 600-1,600° C., by self-sustaining reaction. In some embodiments, the process includes maintaining the reactant gas mixture at a pressure of about 100-32,000 kPa (about 1-320 atmospheres), preferably about 200-10,000 kPa (about 2-100 atmospheres), while contacting the catalyst.

In some embodiments, the process comprises mixing a methane-containing hydrocarbon feedstock and an O₂-containing feedstock together in a carbon:O₂ ratio of about 1.5:1 to about 3.3:1, preferably about 1.7:1 to about 2.1:1, and more preferably about 2:1. Preferably the methane-containing feedstock is at least 50% methane. These and other embodiments, features and advantages of the present invention will become apparent with reference to the following description and drawings.

### BRIEF DESCRIPTION OF THE DRAWINGS

FIGS. 1A-C are scanning electron micrograph images of sequential sections of a rhodium/samarium-loaded submicron-particle-modified monolith prepared in accordance with one embodiment of the present invention. FIG. 1A indicates alumina. FIG. 1B indicates the monolith (without any screen). FIG. 1C indicates rhodium.

FIGS. 2A-C are scanning electron micrograph images of sequential sections of rhodium/samarium loaded unmodified monoliths. FIG. 2A indicates background “noise.” FIG. 2B indicates the monolith (without any screen), and FIG. 2C indicates rhodium.

FIG. 3 is a catalyst performance graph showing methane (diamond) and O₂ (lighter square) conversion, H₂ (circle), CO (lighter star), ethane (circle), ethylene (darker square) and CO₂ (darker star) selectivities for a representative submicron particle enhanced catalyst according to an embodiment of the invention.

FIG. 4 is a graph showing the ratios and mass balances associated with the performance run of FIG. 3.

FIG. 5 is a cross-sectional view of the interior of a short contact time reactor employed for synthesis gas production according to an embodiment of the present invention.

### DETAILED DESCRIPTION OF PREFERRED EMBODIMENTS

Definitions

For the purposes of this disclosure, the following terms are defined as follows:

“Catalytically active material” has its usual meaning and can also include promoters.

“Monolith” is any singular piece or material of continuous manufacture such as a solid foam, honeycomb structure, straight channel extrudate, or other configuration having longitudinal channels or passageways or tortuous pathways, preferably permitting high space velocities with minimal pressure drop. Such configurations are well-known in the art.

“Submicron-size particle” refers to a particle that is less than one micron (μm) in diameter or in its longest dimension.

“Refractory support” refers to a material that is mechanically stable to the high temperatures of a catalytic partial oxidation reaction, which is typically 500° C.-1,600° C., but may be as high as 2000° C.

“Distinct” or “discrete” structures or units refer to supports in the form of divided materials such as granules, beads, pills, pellets, cylinders, trilobes, extrudates, spheres or other rounded shapes, or another manufactured configuration. The term also includes divided material in the form of irregularly shaped particles.

“Autothermal” means that after initiation of the partial oxidation reaction, no additional or external heat must be supplied to the catalyst in order for the production of synthesis gas to continue. Under autothermal reaction conditions the feed is partially oxidized and the heat produced by that exothermic reaction drives the continued net partial oxidation reaction. Consequently, under autothermal process conditions there is no external heat source required.

“Partially stabilized zirconia” (PSZ) refers to a support made by the well-known practice of adding stabilizing oxides, such as MgO, CaO, or Y₂O₃, into the ZrO₂ structure in a sufficient amount to form a solid solution or a mixture of ZrO₂ in different phases. The resulting material has higher resistance to phase transformation during heating and cooling compared to pure ZrO₂.

Preparation of a submicron-size particle enhanced catalyst necessitates obtaining refractory submicron-size particles (i.e., <1 micrometer in diameter or in its longest dimension), a larger refractory support or carrier (e.g., a foam monolith) which may be comprised of the same or different material than the refractory material of the submicron-size particles, and a catalytically active material. The preferred basic procedure for making a submicron-size particle enhanced catalyst generally includes (not necessarily in the order given): a) depositing or impregnating the catalytically active material on at least the submicron-size particles, and b) coating the carrier with the submicron-size particles.

Preferably the procedure comprises: a) first, coating or attaching the refractory submicron-size particles onto a larger refractory support structure or carrier, and then b) depositing or impregnating a catalytically active material on a larger support structure or carrier containing the pre-coated submicron-size particles.

Alternatively, the procedure can comprise: a) mixing the submicron-size particles and the catalytically active material together to form a slurry; and then b) applying the slurry to the carrier to coat the carrier with the submicron-size particles and the catalytically active material.

Although less preferred, a third alternative procedure can be used which includes a) depositing or impregnating the submicron-size particles with the catalytically active material; b) optionally, resizing the deposited particles in order to obtain loaded submicron-size particles; and c) coating or attaching the sized, loaded submicron-size particles onto the surfaces of the larger carrier structure. “Loaded particles” are particles that have been impregnated with the catalytically active material or upon which the catalytically active material has been deposited.

In each of these alternative protocols, a drying step is optionally, but preferably, carried out after depositing the catalytically active material or coating the submicron-size particles. Preferably, the drying is carried out at a temperature between 80° C. and 150° C. Similarly, it is preferred to carry out a heat treatment in air after the deposition of the submicron-size particles or the catalytically active material. It is preferred to heat treat, or calcine, the carrier, after deposition of the submicron-size particles, at a temperature between 500° C. and 1200° C., more preferably between 600° C. and 1000° C. It is also preferable to calcine the catalyst, or an intermediate thereof, after deposition of the catalytically active material. In this case, the calcination is carried out at a temperature between 300° C. and 900° C., more preferably between 400° C. and 700° C. An “intermediate” refers to the catalyst at some stage during its preparation, before it is becomes the finished catalyst ready to use in a reactor for catalyzing the production of synthesis gas.

In some situations, a packed bed of particulate or divided catalyst may be preferred over a monolith catalyst. For example, if the reactor configuration allows, a particulate catalyst bed can be continuously or intermittently removed and refreshed in order to avoid periodically shutting down the reactor to replace or regenerate spent catalyst. Particulate catalysts containing submicron-size particle coatings are prepared similarly to the monolith catalysts described above. In this case, a larger catalyst sphere (e.g., 1 mm in diameter) is coated on its surface with submicron-size support particles bearing the catalytic material.

The larger particulate carrier structure is preferably in the form of a sphere, however it can be readily appreciated that other regular or irregular forms or shapes such as granules, particles, pellets, beads, cylinders, trilobes or other manufactured shapes or geometries that provide satisfactory engineering performance could also be used as carriers for the submicron-sized particles. The size of the carrier particles are chosen such that a bed of the particles will have a pressure drop no less than 0.1 psi/cm (0.7 kPa/cm), preferably no less than 0.2 psi/com (1.4 kPa/cm), and still more preferably no less than 0.5 psi/cm (3.4 kPa/cm). Preferably at least 50%, more preferably 70% or more, of the carrier particles are 50 to 6000 microns in diameter when forming a catalyst bed 12 mm long×12.5 mm diameter catalyst bed (e.g., for a laboratory-scale syngas production reactor operating at superatmospheric pressure and gas hourly space velocity in excess of 100,000 h⁻¹). The preferred catalyst bed length to diameter ratio (L/D) is between about 0.05 and about 1.0; the more preferred range of L/D is about 0.1 to about 0.5, while the most preferred range of L/D is about 0.15 to about 0.40.

Suitable refractory carriers, either in the form of a monolith or in the form of divided units, preferably contain metal oxides such as zirconia, alumina, α-alumina, cordierite, titania, mullite, zirconia-stabilized α-alumina, partially stabilized zirconia (PSZ) foam (stabilized with Mg, Ca or Y), MgO stabilized alumina, and niobia, combinations of those materials, or another similar refractory material. Preferred foams for use in the preparation of a monolith carrier include those having from 30 to 150 pores per inch (12 to 60 pores per centimeter). A highly preferred laboratory-scale ceramic monolith support is porous PSZ foam with approximately 6,400 channels per square inch (80 pores per linear inch). The monolith can be cylindrical overall, with a diameter corresponding to the inside diameter of the reactor tube (e.g., 12.5-13 mm).

### EXAMPLE 1

### 4% Rh/5% Sm on Submicron-Particle-Enhanced PSZ Monolith

An 80 ppi PSZ monolith ½″ diameter×⅜″ long was immersed in a slurry made by mixing 2.5 wt % magnesium nitrate and 20% submicron alpha alumina in a 0.2M aluminum nitrate solution. The slurry is preferably acidic, more preferably slightly acidic, with a pH between 2 and 6.5. The pH may be adjusted by addition of a pH-adjusting solution comprising for example nitric acid or acetic acid. After adjusting the pH to between 2 and 6.5, the monolith was soaked in the slurry during continuous rotation for 3 hours. The monolith, coated with wet slurry, was then blown gently with an air jet to remove excess slurry. The wet-coated monolith was dried at 120° C. for 16 h and finally calcined at 800° C. for 2 h, to yield a modified PSZ monolith. Without wishing to be bound to a particular theory, it is believed that the added magnesium serves as a structural promoter, and that the aluminum nitrate acts as an adhesive for the alpha alumina, which otherwise would have formed a powdery, chalky film.

The modified PSZ monolith was then impregnated with an aqueous solution of Sm(NO₃)₂.6H₂O using an appropriate quantity sufficient to achieve incipient wetness with the desired loading of Sm. The Sm-loaded modified PSZ monolith was then dried in an oven for 8 h at 120° C. and calcined in air at 500° C. for 3 h. The calcined Sm-loaded PSZ monolith was next impregnated with an aqueous solution of RhCl₃.xH₂O using an appropriate quantity to achieve incipient wetness with the desired loading of Rh. The drying and calcinations were then repeated, as described above.

Catalyst prepared as described above was tested in a reactor for its ability to catalyze the production of synthesis gas.

### EXAMPLE 2

### 4% Rh/5% Sm on Unmodified PSZ Monolith

A PSZ monolith, which had the dimensions of ½″ dia×⅜″ long and 80 ppi, was impregnated with an aqueous solution of Sm(NO₃)_{20.6}H₂O using an appropriate quantity sufficient to achieve incipient wetness with the desired loading of Sm. The Sm-loaded PSZ monolith was then dried in an oven for 8 h at 120° C. and calcined in air at 500° C., 3 h. The calcined Sm-loaded PSZ monolith was next impregnated with an aqueous solution of RhCl₃.xH₂O using an appropriate quantity to achieve incipient wetness with the desired loading of Rh. The drying and calcinations were then repeated, as described above. The physical characteristics and performance of this unmodified Rh/Sm loaded monolith were determined and compared to that of the submicron-particle enhanced monolith of Example 1.

Physical Characteristics of the Supported Catalysts

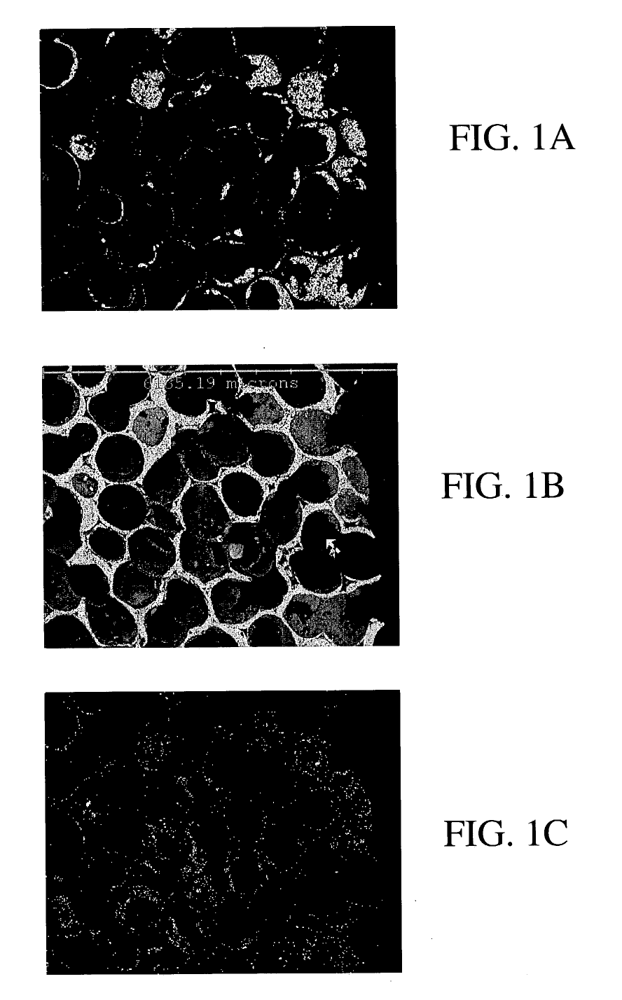

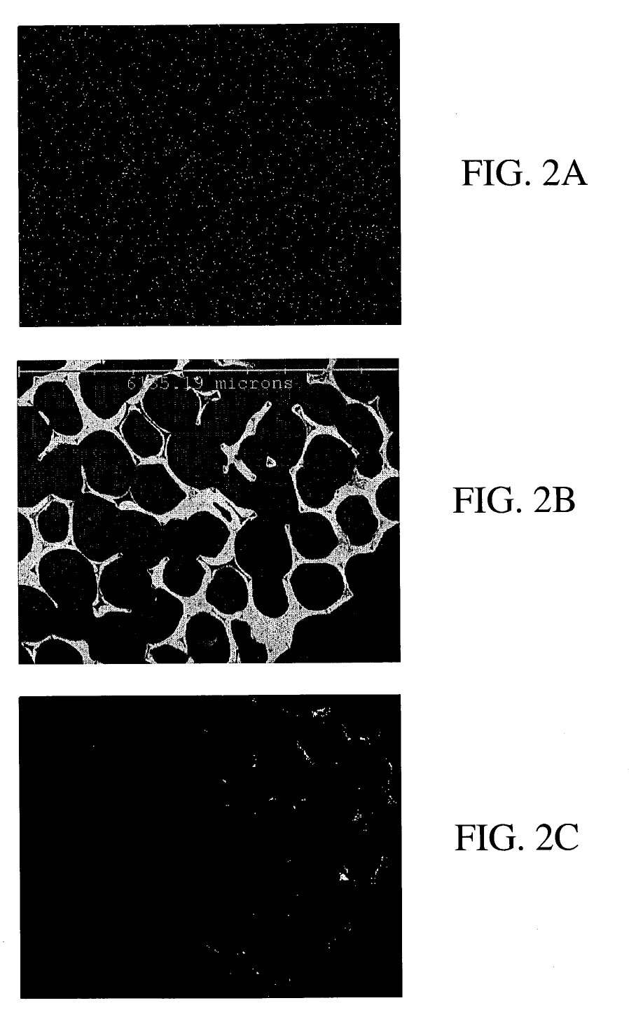

Representative submicron-particle-enhanced monolith catalysts (Example 1; FIGS. 1A-C) and an unmodified monolith catalyst (Example 2; FIGS. 2A-C) were examined with a scanning electron microscope. X-ray microanalysis was performed on sequential sections of each monolith. The results of x-ray mapping each monolith show that a distinct aluminum (Al) phase exists in the submicron-particle-enhanced monolith (FIGS. 1A and 1B) but not in the unmodified monolith (FIGS. 2A and 2B). The Al observed in the unmodified monolith appears to be a background signature or “noise” (FIG. 2A). Rhodium (Rh) is homogeneously distributed on the submicron-particle loaded monolith (FIG. 1C) but not on the plain monolith (FIG. 2C). Rhodium is unevenly dispersed when alumina is not used to deposit the rhodium.

X-ray mapping allows the distribution of elements within a material to be observed visually by displaying the position of each selected element as it resides in the material. The x-rays mapped are a narrow band of energies that correspond to a specific element. These energy bands contain a certain level of background noise that will be present at every point in the map. The x-ray maps are typically scaled with regard to the number of x-rays detected at each point in the material with the brightest areas representing the areas where the most x-rays were detected. Typically the background signal will be insignificant in samples where an element is present, and was scaled essentially to black. Where the element is not present or present at a level not significantly above the background signal, the x-ray map will be a low intensity map across the entire material image. This appears to be the case for Al in the unmodified monolith. (FIG. 2A).

Examination of a cross-section of a representative sample of the final monolith catalyst of Example 1 by scanning electron microscope (SEM) shows that the Rh and Sm crystallites are homogeneously distributed across the channels of the monolith (FIG. 1C.)

Although the preferred techniques for preparing submicron-particle enhanced catalysts are described above, it can be appreciated that other techniques that are known in the field of catalyst synthesis may be substituted, provided that they yield a catalyst that is active for catalyzing the partial oxidation of light hydrocarbons to form synthesis gas, and that comprises (a) a refractory carrier that is larger than 1 micron in diameter or in its longest dimension; (b) suitable catalytically active material, including any promoters; and (c) refractory particles having a diameter or largest dimension that is less than 1 micron. (d) The refractory particles must be attached or affixed to or coating at least some of the surfaces of the carrier. (e) All or some portion of the catalytically active material should be deposited on the refractory particles, or all or a portion of the catalytically active material can be inside the refractory particles. For example, the material could be co-precipitated with a refractory metal oxide. (f) Additionally, a portion of the catalytically active material can be on the refractory carrier. Preferably the physical properties (e.g., as determined by SEM) are similar to those described above for the representative Rh/Sm catalysts.

Performance Characteristics of the Supported Catalysts

The catalytic performance of a representative sample of the above-described 4% Rh/5% Sm containing monolith (Example 1) was assessed in an atmospheric reactor for the catalytic partial oxidation of methane to produce synthesis gas, as described below under “Test Procedure.” A 14.45 mm long monolith (12.5 cm in diameter) weighing 1.887 grams was loaded into the catalyst zone of the reactor. The operating conditions included: oxygen to fuel molar ratio of 0.55, preheat temperature of 300° C. and flow rates of 3500 and 5000 cc/min. The catalyst lit off on the first attempt at 277° C. The velocity at the catalyst bed was 4.6 ft/sec and 6.7 ft/sec for 3,500 cc/min and 5000 cc/min, respectively. The corresponding gas hourly space velocities (GHSVs) at the two flow conditions were 1.82×10⁵ and 2.66×10⁵. The respective outlet temperatures were 660° C. and 693° C., which was lower than that observed in a similar test using a representative unmodified monolith catalyst (Example 2).

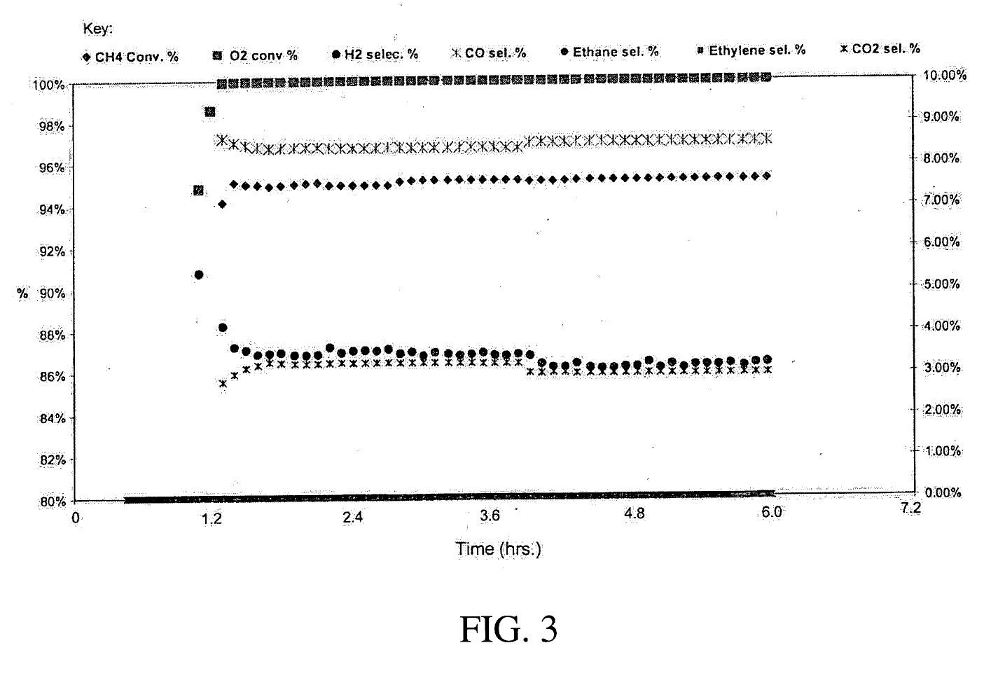

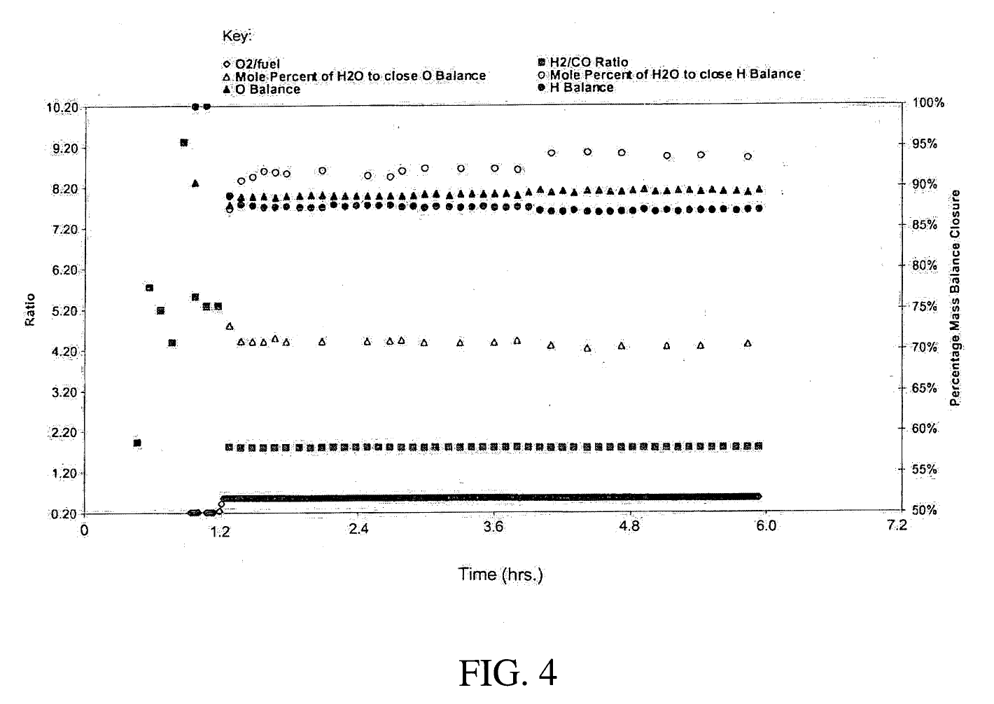

The catalyst performance parameters for the submicron-particle-enhanced monolith catalyst are shown in FIGS. 3-4 and in Table 1. For comparison, the performance parameters for a non-submicron-particle-enhanced (i.e., unmodified), but otherwise similarly loaded Rh/Sm granular catalyst, under similar operating conditions are given in Table 1. As is apparent in FIG. 3, the CO and CO₂ selectivities are inversely proportional and change by 0.2% with increased flow rate. The hydrogen selectivity decreased by 0.5%, however it was lower than that obtained with the unmodified catalyst. No oxygen breakthrough was observed. The observed pressure drop was also lower for the monolith than for the unmodified catalyst granules.

TABLE 1

| | | Conv. | Sel. | Sel. | Sel. | | T | H₂:CO | ΔP |
|---|---|---|---|---|---|---|---|---|---|
| Cat. | Flow | CH₄ | CO | H₂ | CO₂ | GHSV × 10⁵ h⁻¹ | (outlet) | (molar) | (psi) |
| Example 1 | 3500 | 95 | 97 | 87 | 3.2 | 1.82 | 660 | 1.80 | 0.44 |
| | 5000 | 95 | 97 | 86 | 3.0 | 2.66 | 693 | 1.78 | 0.65 |
| Rh/Sm | 3500 | 94 | 96 | 88 | 3.8 | 1.86 | 712 | 1.80 | 1.5 |
| Granules | 5000 | 94 | 97 | 87 | 3.2 | 2.83 | 741 | 1.77 | 2.5 |
| (unenhanced) | | | | | | | | | |

The representative submicron particle enhanced catalyst of Example 1 demonstrated very good activity over the approximately 6 hour test period, comparable to that achieved with a very good syngas catalyst (i.e., unenhanced Rh/Sm coated zirconia granules prepared as described in U.S. patent application Ser. No. 09/946,305, incorporated herein by reference). Only slightly less H₂ selectivity was observed and the level of CO₂ was similar to that of the unmodified granular catalyst. Notably, the submicron particle enhanced catalyst demonstrated a lower pressure drop. The observed outlet temperature was also lower for the monolith of Example 1 than the comparative granular catalyst, when tested under like conditions. The H₂:CO molar ratios were similar for both catalysts at either flow rate, however the ratio decreased slightly with increased flow rate. The feed gas ratios and product gas ratios and mass balances over the approximately 6 hour run period for Example 1 are shown in FIG. 4.

While samarium is a preferred promoter for preparing submicron-particle-enhanced catalysts, another lanthanide could be substituted for combination with rhodium to provide a satisfactory syngas production catalyst. “Lanthanide” refers to a rare earth element of the Periodic Table of the Elements (i.e., La, Ce, Pr, Nd, Pm, Sm, Eu, Gd, Tb, Dy, Ho, Er, Tm or Yb). Although less desirable, the Rh-Sm may instead be pre-impregnated onto MgO-coated submicron-size alumina particles and the loaded particles then applied to the carrier.

As an alternative to using a monolith support, submicron-particle-enhanced divided catalysts can be prepared substantially as described in Example 1, except a similar volume of refractory granules, spheres or the like is substituted for the monolith support structure. Some suitable divided support structures or carriers are granules, spheres, pellets, or other regular or irregular geometry that provides satisfactory engineering performance before being modified by application of the submicron size catalytic materials. Satisfactory support materials include zirconia, MgO modified zirconia, MgO, alpha-alumina, titania, niobia, silica, or any of a wide range of other well-known materials that are capable of serving as a refractory support. The individual granules or divided structures may range in size from 50 microns to 6 mm in diameter (i.e., about 120 mesh, or even smaller, to about 1/4 inch). Preferably the granules or particles are no more than 3 mm in their longest characteristic dimension, or range from about 80 mesh (0.18 millimeters) to about 1/8 inch, and more preferably about 35-50 mesh. The term “mesh” refers to a standard sieve opening in a screen through which the material will pass, as described in the Tyler Standard Screen Scale (C. J. Geankoplis, TRANSPORT PROCESSES AND UNIT OPERATIONS, Allyn and Bacon, Inc., Boston, Mass., p.

837), hereby incorporated herein by reference.

Test Procedure

The partial oxidation reactions were carried out in a conventional flow apparatus using a 19 mm O.D.×13 mm I.D. quartz insert embedded inside a refractory-lined steel vessel. The quartz insert contained a catalyst in the form of at least one porous monolith catalyst (about 12 mm O.D.×15 mm high) held between two foam disks. In the case of the granule-supported catalysts, the granules were packed between the two foam disks about 12 mm diameter and 5 mm thick. The upper disk typically consisted of 65-ppi PSZ and the bottom disk typically consisted of 30-ppi zirconia-toughened alumina. The inlet radiation shield also aided in uniform distribution of the feed gases. An INCONEL®-sheathed, single point K-type (Chromel/Alumel) thermocouple was placed axially inside the reactor, touching the top (inlet) face of the radiation shield. A similar K-type thermocouple was positioned axially touching the bottom face of the catalyst, and was used to indicate the reaction temperature. The catalyst and the two radiation shields were tightly sealed against the inside walls of the quartz reactor by wrapping the shields radially with a high purity (99.5%) alumina paper. A 600-watt band heater set at 90% electrical output was placed around the quartz tube, providing heat to light off the reaction and preheat the feed gases. The bottom of the band heater corresponded to the top of the upper radiation shield. Preheating the methane or natural gas that flowed through the catalyst system provided the heat needed to start the reaction. Oxygen was mixed with the methane or natural gas immediately before the mixture entered the catalyst zone. The methane or natural gas was spiked with propane as needed to initiate the partial oxidation reaction, then the propane was removed as soon as the reaction commenced. Once the partial oxidation reaction commenced, the reaction proceeded autothermally. The molar ratio of CH₄ to O₂ was generally about 2:1, however the relative amounts of the gases, the catalyst inlet temperature and the reactant gas pressure could be varied by the operator according to the parameters being evaluated. The product gas mixture was analyzed for CH₄, O₂, CO, H₂, CO₂ and N₂ using a gas chromatograph equipped with a thermal conductivity detector. A gas chromatograph equipped with flame ionization detector analyzed the gas mixture for CH₄, C₂H₆, C₂H₄ and C₂H₂. The CH₄ conversion levels and the CO and H₂ product selectivities obtained for the catalysts evaluated in this test system are considered predictive of the conversion and selectivities that will be obtained when the same catalyst is employed in a commercial scale short contact time reactor under similar conditions of reactant concentrations, temperature, reactant gas pressure and space velocity.

Process of Producing Syngas

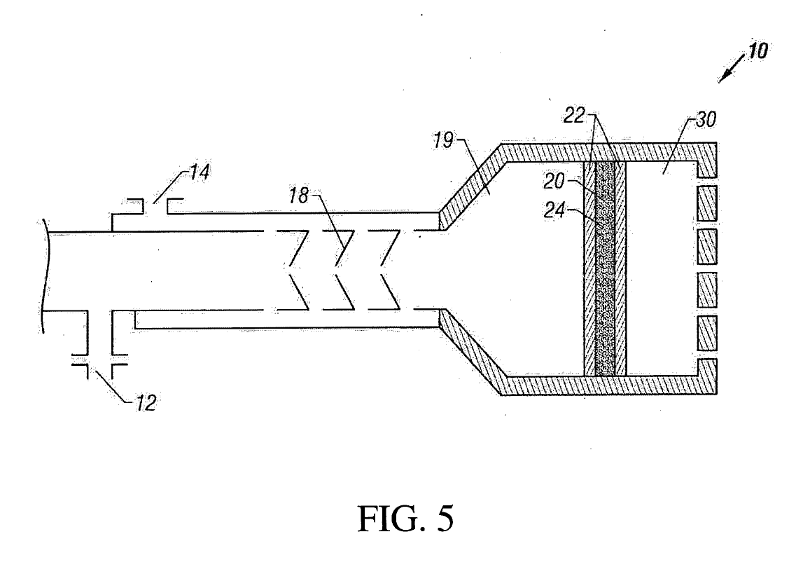

A process for producing synthesis gas employs a submicron particle enhanced monolith or divided catalyst containing rhodium and a lanthanide, preferably samarium for catalyzing the conversion of methane or natural gas and molecular oxygen to primarily CO and H₂ by a net catalytic partial oxidation (CPOX) reaction. Suitable submicron particle enhanced catalysts are prepared as described above. Preferably employing a fast contact (i.e., millisecond range)/fast quench (i.e., less than one second) reactor assembly, a feed stream comprising a light hydrocarbon and an oxygen-containing gas is contacted with the catalyst. Preferably the reactor is operated at a reactant gas pressure greater than 1 atmosphere (>100 kPa), more preferably above 2 atmospheres, which is advantageous for optimizing syngas production space-time yields. One suitable reaction regime is a fixed bed reaction regime, in which the catalyst is retained within a reaction zone in a fixed arrangement, as conceptually illustrated in FIG. 5.

FIG. 5 is a cross-sectional view of the interior of a short contact time reactor 10, suitable for producing synthesis gas by partial oxidation of a light hydrocarbon. Very generally described, the reactor is essentially a tube made of materials capable of withstanding at least the temperatures generated by the exothermic CPOX reaction set out in Reaction 3 (in the case of methane as the feed hydrocarbon). Reactor 10 includes, in sequence, feed injection openings 12 and 14, a mixing zone 19, a reaction zone 20 and a cooling zone 30. In mixing zone 19 is static mixer 18, which can be simply a series of vanes that extend into the flow path of the reactant gas mixture. Reaction zone 20 preferably includes a thermal radiation shield or barrier 22 positioned immediately upstream of a catalyst or catalytic device 24 in a fixed-bed configuration. Radiation barrier 22 is preferably a porous ceramic or refractory material that is suited to withstand the reactor operating temperatures and provide sufficient thermal insulation to the unreacted gases in the mixing zone 19. It is highly preferred that there be a minimum of void or dead spaces in the areas of the reactor that are occupied by the mixing reactant gas in order to minimize the opportunity for gas stagnation and undesirable combustion reactions to occur before the reactant gas stream comes into contact with hot catalyst. A second barrier 22 may be positioned on the downstream side of the catalyst to retain the catalyst bed and to thermally insulate the reacted gases entering cooling zone 30. Such refractory materials are well known in the art. In commercial scale operations the reactor may be constructed of, or lined with, any suitable refractory material that is capable of withstanding the temperatures generated by the exothermic CPOX reaction, or at least 1,600° C., preferably up to about 2,000° C.

The catalyst 24 is positioned in reaction zone 20 in the flow path of the feed gas mixture. The catalyst 24 is preferably in the form of one or more porous monoliths or a bed of discrete or divided units or structures that is held between two porous refractory disks (i.e., irradiation barriers 22). Representative catalytically active lanthanide-promoted Rh containing submicron-particle-enhanced monoliths and divided catalysts are described above. Following the reaction zone 20 is cooling zone 30.

In operation, a stream of light hydrocarbon, such as methane, is fed into feed injection opening 12. Air or oxygen is fed into a second injection opening 14, which is preferably positioned close to catalyst 24. It should be understood that the feed injection openings in the reactor can be configured differently from the configuration shown in FIG. 5 without affecting the principles or operation of the process. For example, O₂ injection opening 14 could be positioned such that the oxygen is mixed with the light hydrocarbon immediately before or during the contacting of the feed gas stream with a hot catalyst. Such configurations may help reduce the occurrence of unwanted side reactions that might otherwise rapidly occur during or after mixing of O₂ with the H₂S and hydrocarbon components but prior to contacting the catalytic surfaces of the reaction zone. Also, the manner of mixing the gases could be modified. Air, or a mixture of air and oxygen can be substituted for the pure oxygen. However, since the presence of N₂ in the reactant gas mixture can be problematic (e.g., forming unwanted nitrogen-containing compounds), it is preferable in most cases to use pure oxygen instead of air. The hydrocarbon feedstock may be any gaseous hydrocarbon having a low boiling point, such as methane, natural gas, associated gas, or other sources of light hydrocarbons or alkanes having from 1 to 5 carbon atoms. The hydrocarbon feedstock may be a gas arising from naturally occurring reserves of methane, which contain carbon dioxide. Preferably, the feed comprises at least about 80% by volume methane. The hydrocarbon feedstock may also include some steam and/or CO₂, as sometimes occurs in natural gas deposits. The methane-containing feed and the O₂-containing feed are mixed in such amounts as to give a carbon (i.e., carbon in methane) to oxygen (i.e., molecular oxygen) molar ratio from about 1.5:1 to about 3.3:1, more preferably, from about 1.7:1 to about 2.1:1. The stoichiometric molar ratio of about 2:1 (CH₄:O₂) is especially desirable in obtaining the net partial oxidation reaction products ratio of 2:1H₂:CO. The hydrocarbon or reactant gas mixture is preferably preheated to about 30° C.-750° C. before contacting the catalyst.

As the feed gases from feed injection openings 12 and 14 flow toward catalytic device 24, they are subjected to thorough mixing by static mixer 18, which can be simply a series of vanes that extend into the flow path of the reactant gas mixture. Alternatively, a more elaborate mixing means could be substituted. During mixing, the feed gases are shielded by radiation barrier 22 from radiant heat that is generated downstream in the process. It is preferred that the temperature on the upstream side of barrier 22 be in the range of about 30° C. to about 500° C., preferably no more than about 750° C., to help initiate the CPOX reaction. Excessive preheating the feed gases can cause unwanted homogeneous reactions to occur that reduce the selectivity of the process for the desired CO and H₂ products. In some instances, it may also be desirable to briefly supplement the hydrocarbon feed with propane or another pure hydrocarbon to facilitate rapid initiation of the CPOX reaction. After the gases pass barrier 22, they flow past catalytic device 24 and are simultaneously heated to 350° C.-2,000° C., preferably not exceeding 1,500° C., and more preferably staying in the range of about 400° C. to about 1,200° C.

The preheated feed gases pass over the catalyst to the point at which the partial oxidation reaction initiates. An overall or net catalytic partial oxidation (CPOX) reaction ensues, and the reaction conditions are maintained to promote continuation of the process, which preferably is sustained autothermally. Under autothermal reaction conditions the hydrocarbon feed is partially oxidized and the heat produced by that exothermic reaction drives the continued net partial oxidation reaction. Consequently, under autothermal process conditions there is no external heat source required.

The gas flow rate is preferably maintained such that the contact time for each portion of the gas stream that contacts the catalyst is no more than about 200 milliseconds, more preferably under 50 milliseconds, and still more preferably 20 milliseconds or less. This degree of contact produces a favorable balance between competing reactions and produces sufficient heat to maintain the catalyst at the desired temperature. Exposure to the hot catalyst and oxygen partially oxidizes the light hydrocarbons in the feed according to the CPOX reaction (Reaction 4, in the case of methane): CH₄+½O₂→CO+2H₂ (4)

It is preferred to keep the stoichiometric molar ratio of carbon:oxygen at about 1.5:1 to 2.2:1, to favor the CPOX reaction. This is best accomplished by monitoring and adjusting during operation the composition, temperature, and flow rates of the feed gases, as further described below. For example, by establishing and maintaining process conditions favoring CPOX over the hydrocarbon combustion reaction (Reaction 5, in the case of methane)

CH₄+2O₂→CO₂+2H₂O (5)

the conversion of the carbon atoms contained in the hydrocarbon molecules to CO₂ is less likely to occur. In this way the CO₂ content of the product gases is minimized and the selectivity for CO and H₂ products is enhanced. In some situations it may be helpful to heat the catalyst using external means, at least at the start of the process, so as to facilitate initiation of the exothermic reactions on the catalyst structure. Once the process is commenced, it is preferably run adiabatically or nearly adiabatically (i.e., without loss of heat), so as to reduce the formation of carbon (e.g., coke) on the surface of the catalyst. Preferably the catalyst is heated sufficiently as a result of the exothermic chemical reactions occurring at its surface to perpetuate the CPOX reaction under favorable conditions of reactant gas molar ratios, flow rate and catalyst contact time. Heating by external means, or otherwise adjusting the temperature toward the higher end of the preferred operating range (i.e., 400° C.-1,500° C.) can allow for increases in the rate at which feed gas can be passed through the catalyst structure while still obtaining desirable reaction products.

The hydrocarbon feedstock and the oxygen-containing gas may be passed over the catalyst at any of a variety of space velocities. Space velocities for the process, stated as gas hourly space velocity (GHSV), are in the range of about 20,000 to about 100,000,000 h⁻¹. Although for ease in comparison with prior art systems space velocities at standard conditions have been used to describe the present invention, it is well recognized in the art that residence time is the inverse of space velocity and that the disclosure of high space velocities corresponds to low residence times on the catalyst. “Space velocity,” as that term is customarily used in chemical process descriptions, is typically expressed as volumetric gas hourly space velocity in units of h⁻¹. Under these operating conditions a flow rate of reactant gases is maintained sufficient to ensure a residence or dwell time of each portion of reactant gas mixture in contact with the catalyst of no more than 200 milliseconds, preferably less than 50 milliseconds, and still more preferably less than 20 milliseconds. A contact time of 10 milliseconds is highly preferred. The duration or degree of contact is preferably regulated so as to produce a favorable balance between competing reactions and to produce sufficient heat to maintain the catalyst at the desired temperature.

In order to obtain the desired high space velocities, the process is operated at atmospheric or superatmospheric pressures. The pressures may be in the range of about 100 kPa to about 32,000 kPa (about 1-320 atm), preferably from about 200 kPa to 10,000 kPa (about 2-100 atm).

The process is operated at a temperature in the range of about 350° C. to about 2,000° C., preferably less than 1,500° C., more preferably the temperature is maintained in the range 400° C.-1,200° C., as measured at the reactor outlet.

The product gas mixture emerging from the cooling zone 30 of reactor 10 is harvested and may be routed directly into any of a variety of applications, preferably at pressure. One such application for the CO and H₂ product stream is for producing higher molecular weight hydrocarbon compounds using Fischer-Tropsch technology.

Net catalytic partial oxidation reaction promoting conditions. The process parameters that can be manipulated or controlled in such a way as to favor the CPOX reaction over other hydrocarbon reactions include optimizing the relative concentrations of hydrocarbon and O₂ in the reactant gas mixture. Preferably the relative amounts of carbon and oxygen are held within the range of about a 1.5:1 to about 3.3:1 ratio of carbon:O₂ by weight, more preferably from about 1.7:1 to about 2.1:1. The stoichiometric molar ratio of about 2:1 (CH₄:O₂) is especially desirable in obtaining a H₂:CO molar ratio of 2:1. Before contacting the catalyst the hydrocarbon or reactant gas mixture is preferably preheated to about 30° C.-500° C., preferably no more than about 750° C., to help initiate the CPOX reaction. Excessive preheating of the feed gases is avoided in order to deter unwanted homogeneous reactions that would reduce the selectivity of the process for the desired CO and H₂ products.

If the situation demands, steam may also be added to produce extra hydrogen and to control (i.e., reduce) the outlet temperature. In this case the ratio of steam to carbon (by weight) preferably ranges from 0 to 1. The carbon:O₂ ratio is the most important variable for maintaining the autothermal reaction and the desired product selectivities. Pressure, residence time, amount of feed preheat and amount of nitrogen dilution, if used, also affect the reaction products. Although less desired, in some instances the reactant gas mixture may be temporarily supplemented with nitrogen to serve as a coolant or diluent. During operation of the reactor, short contact time is maintained which may vary over the range of less than 10 milliseconds up to about 200 milliseconds. Preferably contact time is less than 200 milliseconds, more preferably under 50 milliseconds, and still more preferably 10-20 milliseconds or even less. This is accomplished by passing the reactant gas mixture over the catalyst at a preferred gas hourly space velocity of about 100,000-25,000,000 h⁻¹. This range of preferred gas hourly space velocities corresponds to a weight hourly space velocity of 1,000 to 25,000 h⁻¹.

When employing either a monolith catalyst or a packed bed of divided catalyst, the surface area, depth of the catalyst bed, and gas flow rate (space velocity) are preferably chosen, or adjusted during operation, as applicable, so as to ensure the desired or optimal conversion efficiency and product selectivities. The preferred catalyst bed length to diameter ratio is ≦⅛. Preferably the reactor is operated at a reactant gas pressure greater than 1 atmosphere (>100 kPa), more preferably above 2 atmospheres, which is advantageous for optimizing syngas production space-time yields. Under highly preferred CPOX promoting conditions with a methane feed, the net catalytic partial oxidation of at least 90% of the CH₄ feed to CO and H₂ with a selectivity for CO and H₂ products of at least about 90% CO and 90% H₂ is achieved at 2 atmospheres pressure or more, and at a GHSV of 2,000,000 h⁻¹ or more.

While the preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. For example, the methods and techniques described for preparing supported catalysts for use in production of syngas are also applicable to the preparation of high surface area catalysts having highly dispersed catalytic active sites for use in many other chemical processes. Such other processes include those in which fast reaction rate, high pressure, high space time yield, and/or high temperature are important factors. For instance, the oxidative dehydrogenation of alkanes can be carried out in a reactor similar to the one employed for syngas production and using a catalyst prepared in a similar manner. Accordingly, the scope of protection is not limited by the description set out above, but is only limited by the claims which follow, that scope including all equivalents of the subject matter of the claims. The disclosures of all patents, patent applications and publications cited herein are incorporated by reference. The discussion of certain references in the Description of Related Art, above, is not an admission that they are prior art to the present invention, especially any references that may have a publication date after the priority date of this application.

What is claimed is:

1. A method of making a submicron particle enhanced catalyst, said method comprising:
obtaining refractory particles having a diameter or longest dimension of less than 1 micron;
obtaining a refractory carrier that is larger than one micron in diameter or in its longest dimension;
obtaining a catalytically active material;
depositing said catalytically active material onto at least said particles, or impregnating said particles with said catalytically active material, to provide active material loaded particles; and
coating said refractory carrier with said refractory particles or said active material loaded particles.

2. The method of claim 1 comprising depositing said catalytically active material onto said carrier, or impregnating said carrier with said catalytically active material.

3. The method of claim 1 comprising
attaching said refractory particles to said refractory carrier to provide a refractory particle coated carrier; and then
depositing said catalytically active material onto said particle coated carrier or impregnating said particle coated carrier with said catalytically active material.

4. The method of claim 1 comprising
mixing said refractory particles and said catalytically active material together to form a slurry;
applying said slurry to said carrier.

5. The method of claim 1 wherein said carrier comprises at least one surface, said method comprising:
obtaining refractory particles having a first diameter or longest dimension greater than or equal to 1 micron;
depositing said catalytically active material onto said refractory particles having said first diameter or longest dimension, or impregnating said refractory particles having said first diameter or longest dimension with said catalytically active material to provide loaded particles having a second diameter or longest dimension greater than or equal to 1 micron;
sizing said loaded particles such that said particles have a third diameter or longest dimension less than 1 micron; and
attaching said particles having said third diameter or longest dimension to said at least one surface of said carrier.

6. The method of claim 1 further comprising carrying out at least one of the following steps:
drying said catalyst, or an intermediate thereof, after deposition of said catalytically active material;
drying said catalyst, or an intermediate thereof, after coating said carrier with said submicron-size particles.

7. The method of claim 6 wherein said drying is carried out at a temperature between 80° C. and 150° C.

8. The method of claim 1 comprising heat treating said catalyst, or an intermediate thereof, in air after deposition of said submicron-size particles.

9. The method of claim 8 wherein said heat treating comprises calcining at a temperature between 500° C. and 1200° C.

10. The method of claim 9 wherein said heat treating comprises calcining at a temperature between 600° C. and 1000° C.

11. The method of claim 1 comprising heat treating said catalyst, or an intermediate thereof, in air after depositing or impregnating said catalytically active material.

12. The method of claim 11 wherein said heat treating comprises calcining at a temperature between 300° C. and 900° C.

13. The method of claim 11 wherein said heat treating comprises calcining at a temperature between 400° C. and 700° C.

14. The method of claim 1 comprising selecting a carrier comprising a refractory material chosen from the group consisting of zirconia, alumina, cordierite, titania, mullite, zirconia-stabilized α-alumina, partially stabilized zirconia, stabilized alumina, silica, vanadia, niobia, carbides, nitrides, and combinations thereof.

15. The method of claim 14 wherein said partially stabilized zirconia contains a stabilizer chosen from the group consisting of Mg, Ca and Y.

16. The method of claim 1 wherein said carrier comprises a monolith or a plurality of discrete units.

17. The method of claim 16 wherein at least a majority of the discrete units have a maximum characteristic length greater than 1 micrometer and less than six millimeters.

18. The method of claim 17 wherein at least a majority of the discrete units are generally spherical with a diameter less than 3 millimeters.

19. The method of claim 1, wherein said catalytic material comprises rhodium and a lanthanide chosen from the group consisting of Pr, Sm, and Yb.

20. The method of claim 9 wherein said catalytically active materials comprise about 0.5-10 wt % Rh and about 0.5-10 wt % Sm.

21. A catalyst comprising the product of the method of claim 1.

22. A catalyst active for catalyzing the partial oxidation of light hydrocarbons to form synthesis gas, said catalyst comprising:
a refractory carrier that is larger than 1 micron in diameter or in its longest dimension;
catalytically active material; and
refractory particles having a diameter or largest dimension less than 1 micron, said particles affixed to or coating said refractory carrier,
at least a portion of said catalytically active material being on and/or in said refractory particles, and, optionally, at least a portion of said catalytically active material being on said refractory carrier.

23. A method of partially oxidizing a reactant gas mixture containing a light hydrocarbon and oxygen to form a product mixture containing carbon monoxide and hydrogen, the method comprising:
passing said reactant gas mixture over a catalyst bed comprising the catalyst of claim 22, whereby a product gas mixture containing CO and H₂ is produced.

24. The method of claim 23 comprising passing said reactant gas mixture over said catalyst at a gas hourly space velocity of at least 20,000 h⁻¹.

25. The method of claim 23 comprising passing said reactant gas mixture over said catalyst at a gas hourly space velocity up to 100,000,000 h⁻¹.

26. The method of claim 23 further comprising maintaining said reactant gas mixture at a pressure in excess of 100 kPa while contacting said catalyst.

27. The method of claim 27 wherein said pressure is up to about 32,000 kPa.

28. The method of claim 26 wherein said pressure is in the range of about 200-10,000 kPa.

29. The method of claim 23 comprising maintaining a catalyst residence time of no more than 200 milliseconds for each portion of said reactant gas mixture passing said catalyst.

30. The method of claim 29 comprising maintaining a catalyst residence time of no more than 20 milliseconds.

31. The method of claim 23 further comprising preheating said reactant gas mixture to a temperature in the range of about 30° C.-750° C. before contacting said catalyst.

32. The method of claim 23 wherein said reactant gas mixture comprises a carbon:oxygen molar ratio of about 1.5:1 to about 3.3:1.

33. The method of claim 23 wherein said reactant gas mixture comprises a carbon:oxygen molar ratio of about 2:1.

34. The method of claim 23 wherein said hydrocarbon comprises at least about 50% methane by volume.

35. The method of claim 23 further comprising adding a combustible gas to said reactant gas mixture sufficient to initiate a net catalytic partial oxidation reaction.

36. The method of claim 23 comprising maintaining autothermal catalytic partial oxidation promoting conditions.

37. The method of claim 36 wherein maintaining autothermal catalytic partial oxidation reaction promoting conditions comprises:
regulating the relative amounts of hydrocarbon and O₂ in said reactant gas mixture,
regulating the preheating of said reactant gas mixture,
regulating the operating pressure of said reactor,
regulating the space velocity of said reactant gas mixture, and
regulating the hydrocarbon composition of said hydrocarbon containing gas.

38. The method of claim 37 wherein maintaining autothermal catalytic partial oxidation reaction promoting conditions includes keeping the preheat temperature of the reactant gas mixture in the range of 30° C.-750° C. and the temperature of the catalyst in the range of 350° C.-1,200° C.

39. The method of claim 23 wherein said catalyst bed has a pressure drop of no less than 0.1 psi/cm (0.7 kPa/cm).

40. The method of claim 23 wherein said catalyst bed has a pressure drop of no less than 0.2 psi/com (1.4 kPa/cm).

41. The method of claim 23 wherein said catalyst bed has a pressure drop of no less than 0.5 psi/cm (3.4 kPa/cm).

42. The method of claim 23 wherein said catalyst bed comprises a plurality of carrier particles, at least 50% of which have a diameter or longest dimension in the range of 50 to 6000 microns.

43. The method of claim 23 wherein said catalyst bed has a length to diameter ratio (L/D) between about 0.05 and about 1.0.
